(19) United States
(12) Patent Application Publication
(10) Pub. No.: US 2008/0103906 A1
(43) Pub. Date: May 1, 2008

(54) Online publishing of multimedia content

(76) Inventor: Gurvinder Singh, San Francisco, CA (US)

Correspondence Address: Ashok Tankha;Of Counsel, Lipton, Weinberger & Husick, 36 Greenleigh Drive, Sewell, NJ, 08080, US

(21) Appl. No.: 11/901,802

(22) Filed: Sep. 19, 2007

Related U.S. Application Data
(60) Provisional application No. 60/863,090, filed on Oct. 26, 2006.

(51) Int. Cl. G06F 17/00; G06F 15/16; G06Q 30/00

(52) U.S. Cl. 705/14; 705/1; 709/206; 715/202

(57) ABSTRACT

The method and system disclosed herein publishes user created multimedia content including voice, video, text, pictures, and a combination thereof on one or more publication virtual spaces, simultaneously. A client application, provided on a mobile device, creates and transfers the multimedia content to a publishing service. A protocol is provided for synchronizing user preferences of the publication virtual spaces between the client application and the publishing service. The multimedia content may be transferred as a single multimedia file, data segments, or electronic mail attachments to a back end service of the publishing service via a front end service. The back end service creates a multimedia object from the transferred multimedia content. The back end service splices targeted advertisements with the multimedia object. The multimedia object is transferred from the back end service to the front end service and then published on the publication virtual spaces chosen by the user.

### CROSS REFERENCE TO RELATED APPLICATION

This application claims the benefit of provisional patent application no. U.S. 60/863,090 titled “One Click Mobile Media Casting Without Dialing A Phone Number” filed on Oct. 26, 2006 in the United States Patent and Trademark Office.

### BACKGROUND

This invention, in general, relates to distribution of multimedia content. More particularly, this invention relates to publishing user created multimedia content on one or more publication virtual spaces simultaneously with minimal input actions on a mobile device required of a user.

A user may need to create multimedia files and publish the multimedia files on the internet in real time. The user typically uses a plurality of devices to create the multimedia contents and an additional device with internet capability to publish the multimedia content. Consider a situation where a user needs to create and publish multimedia content comprising a plurality of images and voice content. The user may need to use a camera for capturing the images and a voice recorder for recording the voice content. Furthermore, the user may use a computer with internet capabilities to combine the separate media contents and publish the multimedia content online. It may be inconvenient for the user to operate a plurality of devices in order to create and publish the multimedia content on a website on the wireless internet or intranet. There is an unmet need for a method and system to create and publish multimedia contents online using a single device and with minimal user input actions required of a user.

Moreover, a user may need to publish multimedia content on a plurality of websites. The websites may be controlled by different administrative domains and these websites may have different web properties. Therefore, there is a need for a method and system that enables a user to publish a user created multimedia content on multiple internet or intranet websites.

### SUMMARY OF THE INVENTION

The method and system disclosed herein addresses the above stated needs for publishing user created multimedia content using a mobile device on one or more publication virtual spaces simultaneously. The method and system disclosed herein targets advertisements on the mobile device and the publication virtual spaces using the published multimedia content.

The method and system disclosed herein provides a client application on the mobile device of the user. The client application enables the user to create multimedia content on the mobile device. The user may register on a website of a publishing service prior to using the client application. The user creates a user profile on the website of the publishing service. The method disclosed herein further provides a protocol for synchronizing user publishing information between the client application and the publishing service, wherein the user publishing information includes user preferences of the publication virtual spaces. The client application provides a graphical user interface for the user to record and transfer the multimedia content with minimal user input actions on the graphical user interface. Depending on the processing and memory capabilities of the mobile device, the client application may transfer the user created multimedia content to a back end service via a front end service of the publishing service, as a single multimedia file or as multiple data segments. The user created multimedia content may also be transferred to the publishing service as electronic mail attachments. In the case of a mobile device with limited memory and processing capabilities, the client application partitions the user created multimedia content stored on the mobile device into data segments. These data segments are tagged with segment identifiers using the client application. The tagged data segments are transferred from the client application of the mobile device to the publishing service via a network. The network may also be, but not limited to, one of a cellular network, wireless network, and the internet.

The publishing service comprises the front end service and the back end service. The tagged data segments are received by the front end service, and transferred to the back end service. The back end service reassembles the data segments in a predetermined sequence using the segment identifiers to create a multimedia object. The multimedia object may, therefore, be obtained from the data segments, a single multimedia file, or from electronic mail attachments of the user created multimedia content. Targeted advertisements may be spliced with the multimedia object using the back end service. Also, targeted advertisements may be displayed to the user on the client application of the mobile device. Furthermore, the targeted advertisements may be selected using at least one of a user profile, time, day, and date metrics, advertisement campaigns, and preferences of viewers of the published multimedia content. The multimedia object is then transferred from the back end service to the front end service. The front end service then publishes this multimedia object on one or more publication virtual spaces according to user preferences.

The disclosed method and system also enables a user to publish user created multimedia content on internet or intranet with minimal user input actions on the mobile device. The disclosed method and system, therefore allows for instantaneous user demographic dependent advertising with the user created multimedia content. Furthermore, the disclosed method and system enables a user to publish multimedia content on a plurality of chosen websites. The method and system disclosed herein may not require dialing of a phone number for the publication of multimedia content, thereby providing a publishing service free of charge to the user by using advertising as a business monetization method.

Moreover, the method disclosed herein collects viewing information of the published multimedia content. The publishing service receives the viewing information each time the multimedia object spliced with targeted advertisements is viewed on the publication virtual spaces. The publishing service utilizes the viewing information to generate advertising statistics. The advertising statistics gives the advertisers the option to pay for each viewing of the advertisement instead of a fixed rate of payment.

Furthermore, the method and system disclosed herein enables users to create multimedia files and then publish the files on the internet in real time. The user created multimedia files may also be shared with others with minimal input actions required by the user handling the mobile device. The method and system disclosed herein also enables video blogging, text blogging, picture blogging, and voice blogging in a publisher independent manner to one or multiple sites on the internet or intranet.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of publishing user created multimedia content on one or more publication virtual spaces.

FIG. 2 illustrates a system for publishing user created multimedia content on one or more publication virtual spaces.

FIG. 3 exemplarily illustrates the publishing of multimedia content on one or more publication virtual spaces using the client application on the mobile device.

FIG. 4 illustrates an exemplary flowchart of the process of publishing the user created multimedia content on one or more publication virtual spaces.

FIG. 5 illustrates an exemplary flowchart of the transfer of multimedia content to the publishing service in the form of electronic mail attachments.

### DETAILED DESCRIPTION OF THE INVENTION

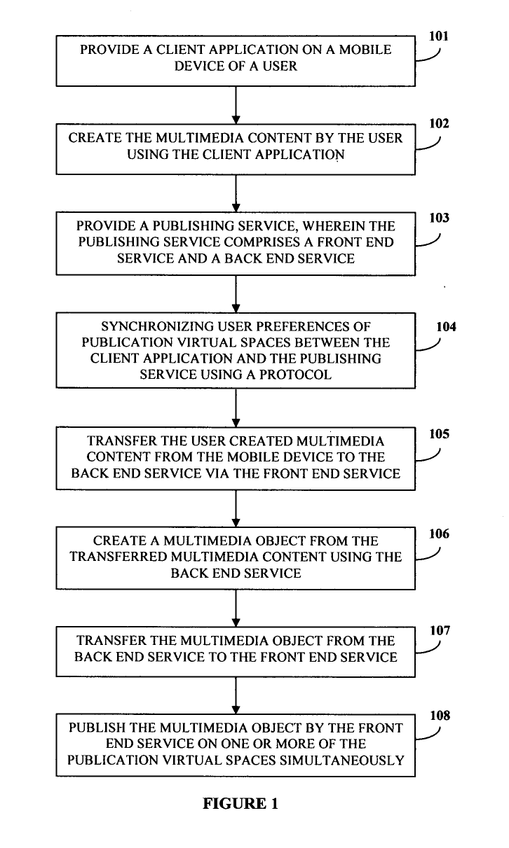

FIG. 1 illustrates a method of publishing user created multimedia content on one or more publication virtual spaces 205. The method disclosed herein provides 101 a client application 202 on a mobile device of a user 201. The user 201 may register on a website of a publishing service 204 prior to using the client application 202. The user 201 may also register on the publication virtual spaces 205 by creating a user profile at the publication virtual spaces 205. The user 201 creates 102 multimedia content by using the client application 202. The client application 202 provides a graphical user interface 202a to the user 201 to record and transfer the user created multimedia content to the publishing service 204. The user created multimedia content may be an audio file, a video file, an image file, a text file, or any combination thereof.

The method disclosed herein further provides 103 the publishing service 204 comprising a front end service 204b and a back end service 204c. The client application 202 interacts with the publishing service 204 to determine the preferred websites or publication virtual spaces 205 of the user 201 for publishing the user created multimedia content. The user 201 may select one or more publication virtual spaces 205 using the client application 202, as a preferred destination for publishing the user created multimedia content. The client application 202 communicates the user publishing information including the user preferences of the publication virtual spaces 205 to the front end service 204b. In one embodiment, the publication virtual spaces 205 may be selected on the website of the publishing service 204. The method disclosed herein provides a protocol for synchronizing 104 user publishing information between the client application 202 and the publishing service 204. The user publishing information includes user preferences of the publication virtual spaces 205. The user created multimedia content is received by the front end service 204b of the publishing service 204 from the client application 202 and then transferred 105 to the back end service 204c of the publishing service 204.

The user created multimedia content is transferred using the internet or intranet capabilities of the mobile device over a network. Exemplarily, the network is a wireless network. Depending on the hardware processing and memory capabilities of the mobile device, the client application 202 may transfer the user created multimedia content to the publishing service 204 as a single multimedia file or as multiple data segments. The user created multimedia content may also be transferred as electronic mail attachments. The user created multimedia content may be reviewed prior to transferring the multimedia content to the publishing service 204. Moreover, in remote locations where there is limited or absence of network connectivity, the multimedia content may be prerecorded and stored on the mobile device, and later transferred to the publishing service 204 when the network connectivity is established.

The network 203 may be a wireless network, a cellular network, a telephony network, the internet or intranet. In one implementation of the invention, the client application 202 uses the telephony network to access the internet and transfers the user created multimedia content to the front end service 204b. In another implementation of the invention, the front end service 204b may be accessible via a toll free number. The user 201 calls the toll free number and records voice messages at the front end service 204b. These voice messages serve as the multimedia content that needs to be published.

The back end service 204c creates 106 a multimedia object from the transferred multimedia content. The back end service 204c may splice the multimedia object with targeted advertisements based on a user profile stored in the database 204a of the publishing service 204. Also, when the user 201 is using the client application 202 targeted advertisements may be displayed to the user 201 on the client application 202. Targeted advertisements are selected from the database 204a provided in the publishing service 204. Targeted advertisements are selected using information from at least one of a user profile, time, day, and date metrics, advertisement campaigns, preferences of viewers of the published multimedia content, and the type of publication virtual spaces 205.

If the multimedia object comprises video and audio content, the targeted advertisements are spliced with the visual part of the user created multimedia content. In case of a slide show with only video content, the advertisements may be inserted at the beginning and the end of the video message. If the user created multimedia content comprises only an audio content, the targeted advertisements may be displayed as images or streaming video on the publication virtual spaces 205 while the user created audio content is being played. The advertisements may be inserted in the beginning and the end of a multimedia message to maintain the flow and continuity of the message. In a voice-only message, a static visual component such as an image may be attached to the message. This visual component may also be included as a slide show if there are multiple advertisements to be displayed. Also, advertisements may be displayed to the user 201 on the mobile device, while the user 201 is using the client application 202 for recording and publishing the multimedia content.

The multimedia object is then transferred 107 from the back end service 204c to the front end service 204b. The multimedia object is published 108 by the front end service 204b according to the user preferences on one or more publication virtual spaces 205 via the network 203. The user preferences may comprise authentication credentials, transaction identification, a list of publication virtual spaces 205, global positioning system geographical codes, area code for the phone number of the mobile device, file format of the user created multimedia content, and a compression rate of the multimedia content. The user 201 stores these preferences during registration with the publishing service 204. The publishing service 204 may also collect viewing information each time the multimedia object is viewed on the publication virtual spaces 205. The viewing information is used to generate advertising statistics. The multimedia object may be published by a single input action of the user 201. Depending on the interface provided by the mobile device, the single input action of the user 201 may be a click or touch of a button provided on the graphical user interface 202a of the mobile device, a voice command, or a turn of a scroll wheel on the mobile device.

In one embodiment where the mobile device of the user 201 has limited memory and processing capabilities, the user created multimedia content may be streamed as data segments from the mobile device to the publishing service 204. The data segments are individually tagged with segment identifiers by the client application 202 and transferred 105 from the mobile device to the back end service 204c of the publishing service 204 via the front end service 204b. The data segments are transferred from the mobile device to the publishing service 204 via the network 203. The segment identifiers comprise transaction identifiers, sequence numbers, timestamps, etc. The back end service 204c of the publishing service 204 reassembles the data segments in a predetermined sequence using the segment identifiers to create 106 the multimedia object. The multimedia object is an aggregation of the reassembled data segments. The back end service 204c may then splice the multimedia object with targeted advertisements based on the user profile. The multimedia object is then transferred 107 from the back end service 204c to the front end service 204b and published 108 by the front end service 204b on one or more publication virtual spaces 205 according to user preferences.

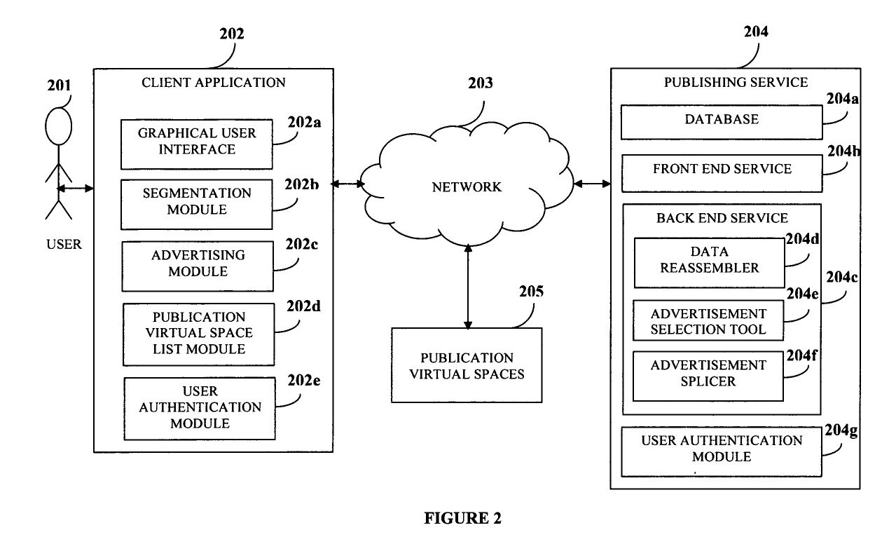

FIG. 2 illustrates a system for publishing user created multimedia content on one or more publication virtual spaces 205. The disclosed system comprises a client application 202 on the mobile device and a publishing service 204. The client application 202 enables the user 201 of the mobile device to record and transfer the user created multimedia content to the publishing service 204. The user 201 may register on a website of the publishing service 204 prior to using the client application 202. The user 201 may create an account comprising the user profile and login information of the publication virtual spaces 205 configured on the mobile device of the user 201. The client application 202 comprises a graphical user interface 202a (GUI), a segmentation module 202b, an advertising module 202c, a publication virtual space list module 202d, and a user authentication module 202e.

When the user 201 starts the client application 202 on the mobile device, the user 201 may be authenticated by the user authentication module 202e. The GUI 202a presents a simple user interface to the user 201 to start the publishing process. On a single click or touch of a record button provided on the GUI 202a, the user 201 may start recording the multimedia content immediately. A media recorder available on the mobile device is used to record the multimedia content. The media recorder may be one of a video recorder, an audio recorder, etc. The user 201 may optionally choose the medium for recording the multimedia content. For example, the user 201 may want to send a voice message, or a voice message accompanied by photographs. The client application 202 enables the user 201 to record video messages, audio messages, picture messages etc., by selecting the options provided by the GUI 202a. If the recorded message has a video component, the main screen may also display the content being recorded. When the record button is pressed, the media recorder begins recording the message.

The user 201 may also configure multiple publication locations of the publication virtual spaces 205 on the mobile device using the publication virtual space list module 202d. The publication virtual space list module 202d enlists the publication virtual spaces preferred by the user 201 for publishing the user created multimedia content. The publication virtual spaces 205 may be third party social networking websites, blog sites, video blog sites, social book marking websites, shopping websites, merchandising websites, and a plurality of websites that publishes user created multimedia contents. In one embodiment of the invention, the publication virtual spaces 205 may be meta-destinations. The meta-destinations are logical groupings of destinations selected by a user 201. The meta-destinations enable the user 201 to create logical groups of publishers and save the groups of publishers for future use. Moreover, the user 201 may set other users of any system as destinations also. Furthermore, the users may set arbitrary emails and phone numbers as a destination. When the destination is an electronic mail or a phone number, a link via electronic mail, short message service (SMS), or multimedia message service (MMS) is provided in order to view the multimedia content.

Before the recording begins, the user 201 may change the default publication location, and select the publication virtual spaces 205 for the user created multimedia content on the mobile device. The user 201 may also change the quality of the media before recording the message. For example, if compression is available, the user 201 may change the compression rate, and also change both the transfer speed and message quality. The client application 202 may have default settings, but the user 201 may also set preferences on the mobile device. The preferences set by the user 201 may be authentication credentials, transaction identification, list of publication virtual spaces 205, global positioning system geographical codes, area code for the phone number of the mobile device, file format of the user created multimedia content, and compression rate for the user created multimedia content. These user preferences are transferred to the publishing service 204.

The GUI 202a of the client application 202 also provides additional buttons to control the playback of the recorded message. The user 201 may stop the recording, review the message and decide whether to record again. By a single click or touch of the post button provided by the GUI 202a, the recorded message is sent for publication. If a user 201 does not wish to review the recorded message, the user 201 may directly publish the recorded message by clicking the post button. On clicking the post button, the content is published. The click or touch of the post button is the single user input action required to publish the user created multimedia content on one or more publication virtual spaces 205 simultaneously.

The user 201 may also review the recording and rerecord the message. The user 201 may review the recording by clicking a view option provided in the menu of the GUI 202a. In one embodiment of the invention the user 201 may publish prerecorded and stored multimedia messages. When there is limited or no connectivity existing between the mobile device and the publishing service 204, the user 201 may record and store the multimedia messages on the mobile device. The user 201 may select the prerecorded and stored messages and transmit these messages in bulk when the user 201 regains connectivity with the publishing service 204. The prerecorded and stored messages may not be transmitted in real time to the publishing service 204.

In one embodiment of the invention, a voice recognition option may also be provided by the client application 202. When the user 201 starts the client application 202, the recording begins on voice activation. When the user 201 begins to speak, the recording automatically begins. If there is a video message involved, the user 201 may have the video recorder ready once the recording process has begun by voice activation. Once the user 201 stops speaking for a sufficiently long period of time, it is assumed that the user 201 has stopped recording, even if there is a video component being recorded. The client application 202 will recognize that the recording has stopped, and deletes the last recorded silent segment from the final message.

In another embodiment of the invention, the client application 202 has the option to start recording immediately as the client application 202 starts. The message is recorded until the user 201 presses the stop button to finish the recording process. When the stop button is pressed, the recording stops, and the recorded message is immediately published on one or more of the publication virtual spaces 205 configured by the user 201. In this embodiment of the invention, the user 201 may not be allowed to review the multimedia message before publishing the message. The user 201 may however be given the opportunity to change options of the client application 202 before the recording is activated by voice. For example, the user 201 may change the locations of the publication virtual spaces 205, choose compression rates, or add an option to review the recorded multimedia content before publishing the multimedia content. Optional advertisements may also be displayed to the user 201 on the mobile device after the user 201 has published the user created multimedia content by pressing the post button on the mobile device. The advertising module 202c of the client application 202 displays advertisements targeted to the user 201 on the mobile device.

After the multimedia content is recorded by the media recorder, the client application 202 may transfer the user created multimedia content to the publishing service 204 as a single multimedia file or as multiple data segments. The client application 202 may also transfer the user created multimedia content as electronic mail attachments. In the case of limited memory and processing capabilities of the mobile device, the client application 202 partitions the user created multimedia content into data segments using the segmentation module 202b. The segmentation module 202b generates segment identifiers and tags the data segments with the segment identifiers. The segment identifiers may be one or more of transaction identifiers, sequence numbers, and timestamps. The segment identifiers are used later by the back end service 204c of the publishing service 204 to reassemble the data segments in a predetermined sequence to create a multimedia object. The tagged data segments are then transferred from the client application 202 to the publishing service 204 via the network 203. The network 203 may be a wireless network, a cellular network, or the internet.

The publishing service 204 comprises a database 204a, the front end service 204b, a back end service 204c, and a user authentication module 204g. The database 204a of the publishing service 204 comprises user profiles, user preferences, advertisement profiles, advertisements, and user created multimedia content. The user created multimedia content in the form of a single multimedia file, data segments, or electronic mail attachments is received by the front end service 204b of the publishing service 204. The front end service 204b transfers the user created multimedia content to the back end service 204c of the publishing service 204. The front end service 204b provides an application interface for the client application 202 to access the functionalities provided by the back end service 204c. Since the back end service 204c has diverse functions, the front end service 204b also acts as an aggregator of the functionalities of the back end service 204c. The front end service 204b acts as a layer of abstraction that hides the implementation details of the publishing service 204. This abstraction layer ensures that any modifications of either the client application 202 or the back end service 204c are independent of each other.

The back end service 204c of the publishing service 204 comprises a data reassembler 204d, an advertisement selection tool 204e, and an advertisement splicer 204f. The back end service 204c is provided with credentials for user authentication, the user profile, and the user created multimedia content. The user authentication module 204g authenticates the user 201 of the client application 202. If the back end service 204c receives the user created multimedia content in the form of data segments, the data reassembler 204d reassembles the data segments in a predetermined sequence using the segment identifiers. The back end service 204c creates a multimedia object from the user created multimedia content. The multimedia object may therefore be a single multimedia file, an aggregation of the reassembled data segments, or a single multimedia file comprising the electronic mail attachments.

Based on user consent, targeted advertisements may also be spliced with the multimedia object. Targeted advertisements based on the user profile may be selected from the database 204a of the publishing service 204 by the advertisement selection tool 204e. The advertisement selection tool 204e of the back end service 204c selects advertisements from the database 204a based on the user profile 201, time, day, and date metrics, advertisement campaigns, preferences of viewers of the published multimedia content, and the type of publication virtual spaces 205. The selected advertisements are then spliced with the multimedia object by the advertisement splicer 204f of the back end service 204c. The inclusion of advertisements is targeted according to the profile provided by the user 201 during registration with the publishing service 204. In addition to the user profile, information collected from the user 201 based on the user's 201 patterns of usage of the publishing service 204 is also taken into consideration for targeting advertisements.

The back end service 204c then transfers the multimedia object to the front end service 204b. The front end service 204b associates the multimedia object with the user preferences and publishes the multimedia object on one or more publication virtual spaces 205 via the network 203. The multimedia object is transferred with the user authentication credentials to the publication virtual spaces 205. The user 201 is authenticated before publishing the user created multimedia content on the chosen publication virtual spaces 205. The publication virtual spaces 205 may be third party social networking websites, blog sites, video blog sites, social book marking websites, shopping websites, merchandising websites, and a plurality of websites that publishes user created multimedia contents. Targeted advertisements, if included, will also be viewed on the publication virtual spaces 205. The publishing service 204 collects viewing information each time the multimedia object is viewed on the publication virtual spaces 205. This viewing information is used to generate advertising statistics. The user created multimedia content may be published as one of a pod cast, a video cast, a photo cast, a text cast, a voice blog, a photo blog, a text blog, and a combination thereof.

Each of the publication virtual spaces 205 may require the user 201 to create an account prior to publishing user created multimedia content on that publication virtual space 205 by the user 201. The user 201 first creates an account on a desired publication virtual space. The user 201 provides login information comprising a username and a password. The account is created for the user 201 by the publication virtual space 205 and is confirmed. After the user 201 creates an account with the publication virtual space 205, the user 201 registers on a website of the publishing service 204. While registering on the website of the publishing service 204, the user 201 provides the login information of the publication virtual space to the publishing service 204. The login information enables the publishing service 204 to access the multiple publication virtual spaces 205 configured by the user 201 on the mobile device. The user 201 may also provide additional publication virtual spaces 205 at a later time. A plurality of publication virtual spaces 205 may be indicated by the user 201 to the publishing service 204 or one default publication virtual space may be used for publishing the user created multimedia content. The publishing service 204 logs on to the publication virtual space of choice on the user's 201 behalf and publishes the user created multimedia content. The publishing service 204 graphically adds a media player to the publication virtual space allowing viewers to access the multimedia object without having to install additional software.

New publication virtual spaces 205 may be added by the user 201 through the client application 202 or on the website of the publishing service 204. The list of virtual publication spaces 205 displayed on the client application 202 is dynamically updated and synchronized with the latest list residing on the publishing service 204. In addition, the publishing service 204 interacts with different publication virtual spaces 205 to obtain user publishing information from the publication virtual spaces 205. This user publishing information is displayed on the client application 202, so that the user 201 can publish the multimedia content on the relevant pages of the publication virtual spaces 205. The user publishing information of the publication virtual spaces 205, for example, may be, but not limited to, the information of albums in the user's flickr account, of Yahoo Inc., where the user 201 publishes pictures, or the information of an online auction of eBay®, where the user 201 wants to publish a multimedia content, etc. The user publishing information is obtained by the publishing service 204 via a dynamic protocol exchange between the publishing service 204 and the multiple publication virtual spaces 205. The resulting list with the information of the publication virtual spaces 205 is provided to the client application 201 for selection or display purposes.

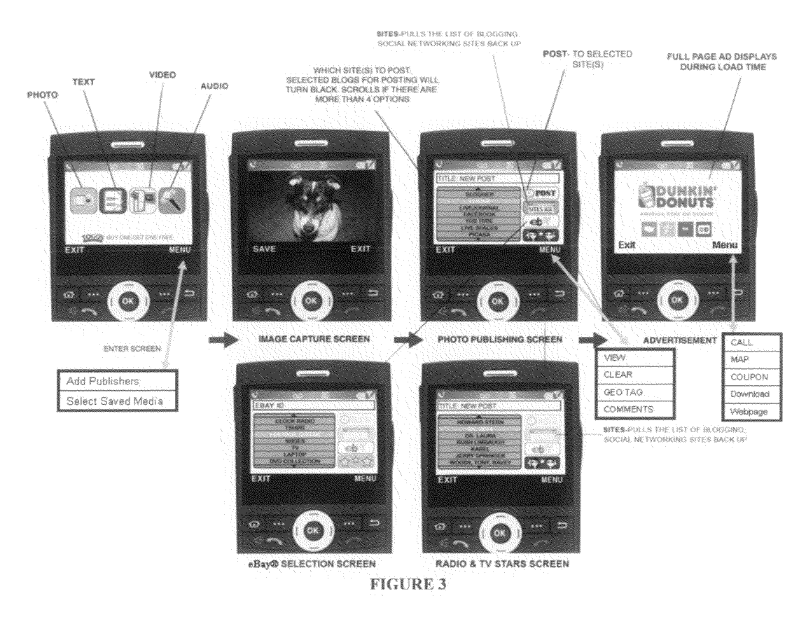

FIG. 3 exemplarily illustrates the publishing of multimedia content on one or more publication virtual spaces 205 using the client application 202 on the mobile device. The ‘enter screen’ as illustrated on the graphical user interface (GUI) 202a of the client application 202 provides options for the selection of the medium for the multimedia content to be created. The user 201 may create photos, text content, video content, audio content, or any combination thereof. The user 201 selects the preferred publication websites or publication virtual spaces 205 using an ‘add publishers’ menu option provided on the ‘enter screen’. The publication virtual spaces 205 are selected from a dynamic list of active publishers for a given user 201. The list of active publishers may be configured by the user 201 on the website of the publishing service 204 or by using the ‘add publishers’ menu option in the client application 202.

After selection of the medium of the multimedia content, the user 201 starts recording the multimedia content. As illustrated in the ‘image capture screen’ of FIG. 3, the user 201 exemplarily captures an image and saves the image. The user 201 then selects the publication virtual spaces 205 configured on the client application 202 using the ‘photo publishing screen’ illustrated in FIG. 3. The menu option provided on the ‘photo publishing screen’ enables the user 201 to edit the captured image or edit the posting of the captured image. For example, the user 201 may view, clear, geo tag, or add comments to the captured image.

On click or touch of the ‘post button’ illustrated on the ‘photo publishing screen’, the user 201 publishes the captured image on one or more of the publication virtual spaces 205 configured on the mobile device. The user 201 publishes the created multimedia content on the selected publication virtual spaces 205, for example, shopping websites such as eBay®, or publishes audio content and video content on radio and television websites. The publishing of the user created multimedia content on the eBay® website is illustrated on the ‘eBay® selection screen’ of FIG. 3. After publishing the user created multimedia content, the user 201 may receive targeted advertisements. For example, the targeted advertisements may be displayed on the ‘advertisement’ screen of the mobile device.

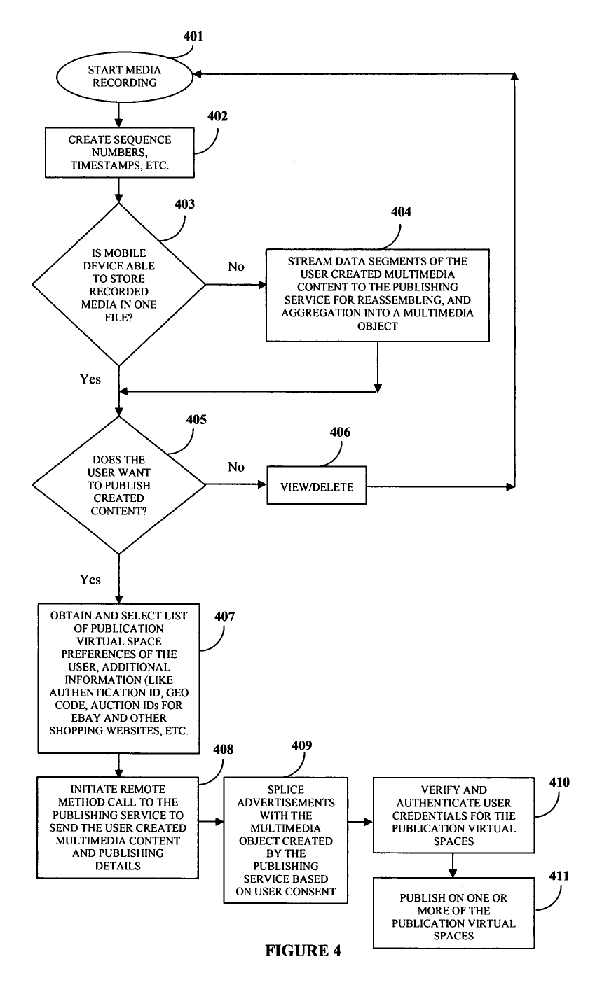

FIG. 4 illustrates an exemplary flowchart of the process of publishing the user created multimedia content on one or more publication virtual spaces 205. The user 201 creates multimedia content using the client application 202 provided on the user's 201 mobile device. Prior to using the client application 202, the user 201 registers on the publication virtual spaces 205 and the website of the publishing service 204. The user created multimedia content may be one of text, audio, video, image, picture, and a combination thereof. The user 201 utilizes the media recorder 202b of the mobile device and begins to record 401 the multimedia content by clicking the record button of the graphical user interface 202a. The time duration of the recording need not be specified by the user 201 prior to recording of the multimedia content. The multimedia content may be transferred to the publishing service 204 as a single multimedia file, data segments, or as electronic mail attachments, depending on the memory and processing capabilities of the mobile device of the user 201.

If the mobile device is not able to store 403 the user created multimedia content in a single multimedia file, the client application 202 partitions the recorded media contents into data segments using the segmentation module 202b. Segment identifiers such as transaction identifier, timestamp, sequence number, etc. are created 402 by the segmentation module 202b and are tagged to each data segment. In case of an audio recording, the audio content is partitioned into audio data segments. In case of a video recording, the video content and the associated audio content are partitioned into video and audio data segments, respectively. The segment identifiers are used for reassembling the data segments in a predetermined sequence to create a multimedia object by the back end service 204c. Furthermore, in the case of a video recording, the segment identifiers are used to synchronize the video data segments and the associated audio data segments during the reassembling of the data segments. The data segments are streamed in real time to the publishing service 204, while the recording of the media content is in progress. The asynchronous real time streaming of the data segments ensures that the most of the recorded media content is available at the publishing service 204 even before the recording is completed, thereby reducing the time taken for transferring the recorded media content from the mobile device to the publishing service 204.

Consider an example, where the user 201 desires to publish a multimedia object comprising two or more media contents. These media contents may be a combination of streaming and non-streaming type of media contents. For example, the first media content of the non-streaming type may be a collection of image files and second media content of the streaming type may be an audio file. The user 201 may desire to publish a slideshow created by these images with the accompanying audio content. The client application 202 transfers the first and the second media contents to the publishing service 204. The publishing service 204 intelligently creates a slideshow with accompanying audio from the still images and the audio file received from the client application 202. The publishing service 204 converts the non streaming type image content to streaming type video content by determining the display duration and the transition period of each image depending on the length of the audio stream.

The client application 202 continually verifies for the completion of the recording of the media contents. In one embodiment of the invention, the completion of the recording of the media content may be signaled to the client application 202 when the user 201 clicks the stop button or the post button on the graphical user interface 202a. In another embodiment of the invention, when an audio or video content is being recorded, the client application 202 may recognize a sufficiently long period of time when there is no audio input. The client application 202 intelligently understands that the recording is completed and the media content is ready for further publishing. After the completion of the recording of the media content, the user 201 may click the post button 301a to publish the recorded media content. The client application 202 then signals the publishing service 204 that the streamed media content is ready to be published.

If the user 201 is not satisfied 405 with the created multimedia object, the user 201 may review or delete 406 the multimedia object and start recording again. Otherwise, the user 201 transfers the multimedia object for publishing to a publication space selected by the user 201. Additional information such as the list of the user preferences of the publication virtual spaces 205, authentication identification, user preferences, default settings, manually entered geographical codes, and auction identifiers for eBay® and other shopping websites are selected 407 and transferred along with the user created multimedia content to the publishing service 204. A remote method call 408 such as extensible markup language-remote procedure call (XML-RPC) may be initiated by the client application 202 to transfer the user created multimedia content along with the additional information to the publishing service 204. The transfer to the publishing service 204 takes place using wireless technology, for example, global system for mobile communications, code division multiple access technology, wireless fidelity, or worldwide interoperability for microwave access.

If the user created multimedia content is streamed 404 as data segments to the publishing service 204, the back end service 204c of the publishing service 204 aggregates 404 the data segments into a multimedia object to reproduce the originally recorded multimedia content. The data segments are reassembled in the back end service 204c of the publishing service 204 using the segment identifiers tagged to the data segments. As illustrated in FIG. 4, the back end service 204c aggregates the data segments into a multimedia object. The multimedia object may therefore be a single multimedia file of the user created multimedia content, the aggregation of the data segments, or a single multimedia file comprising the electronic mail attachments. Based on user consent provided in the user profile stored in the database 204a of the publishing service 204, targeted advertisements may be spliced 409 with the multimedia object created by the back end service 204c.

The multimedia object is transferred to the front end service 204b of the publishing service 204 from the back end service 204c. The front end service 204b associates the multimedia object with the user preferences stored in the database 204a, authenticates 410 the user 201 for a particular publication virtual space and then publishes 411 the multimedia object on the selected publication virtual spaces 205 205. The user 201 is authenticated for particular publication virtual spaces 205 using the authentication details stored in the database 204a of the publishing service 204. Each time the multimedia file created by the user 201 is viewed, a message is sent back to the back end service 204c. This enables the back end service 204c to keep track of the number of viewers for a particular targeted advertisement if advertisements were spliced with the multimedia object.

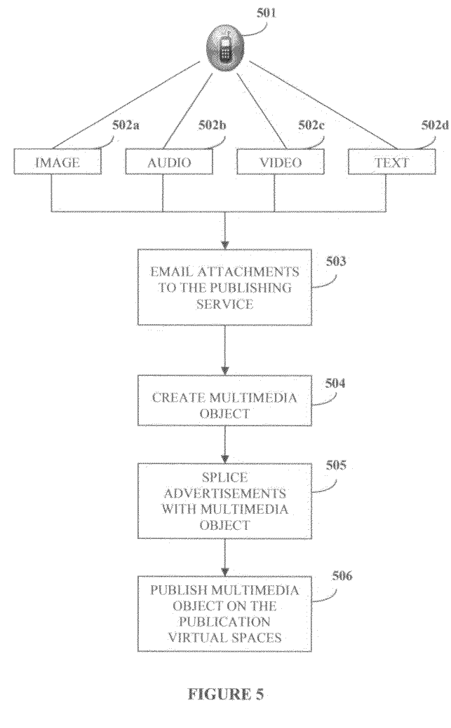

FIG. 5 illustrates an exemplary flowchart of the transfer of multimedia content to the publishing service 204 in the form of electronic mail attachments. As illustrated in FIG. 5, the user created multimedia content considered is one of a picture, an audio, a video, and text file. The user 201 captures images 502a, records audio 502b or video content 502c, and text 502d on the mobile device 501 using the media recorder 202b present in the mobile device 501. The media recorder may be an image capturing tool such a camera for capturing images, or may be an audio or video recorder for recording the audio or video content respectively. The user 201 records the media contents using client application 202. After the recording is complete, the client transfers the recorded media content as electronic mail attachments 503 to the publishing service 204 using an electronic mail client available on the mobile device 501. The publishing service 204 may identify the user 201 by the user's 201 electronic mail address that was provided by the user 201 to the publishing service 204.

In one embodiment illustrated in FIG. 5, the user 201 may send multimedia content through more than one electronic mail attachment to the publishing service 204. Based on the preferences of the user 201, the publishing service 204 may aggregate the contents of the multiple electronic mail attachments, and creates a multimedia object 504. For example, the user 201 may use several images and an audio clip to publish a slideshow with accompanying audio. These images and the audio clip may be sent to the publishing service 204 as multiple attachments in a single electronic mail message or as an attachment in multiple electronic mail messages. In case of the attachments sent over multiple electronic mail messages, the publishing service 204 may identify that the received contents are part of single multimedia content from the subject of the electronic mail messages. For example, the subject of the electronic mail message may contain ‘Media content part 1 of n’, where ‘1’ is the index of the current file that is sent as an attachment, and ‘n’ is the total number of files that the combined multimedia content may comprise. Upon receiving the ‘n’ number of files, the publishing service 204 may aggregate these files, create the final slideshow with accompanying audio, and publish the slideshow one or more publication virtual spaces 205 as desired by the user 201. Based on user consent, targeted advertisements may be spliced with the created multimedia object 505. The multimedia object is then published 506 on one or more of the publication virtual spaces 205 configured by the user 201. The steps of aggregating the transmitted multimedia content 504, splicing advertisements with the multimedia object, and publishing the multimedia object 506 on one or more publication virtual spaces 205 simultaneously is described in the detailed description of FIG. 1.

A user 201 may use the disclosed invention for publishing user created multimedia content using a mobile device in different scenarios. The user 201 may share the multimedia contents with others by publishing the multimedia contents on one or more publication virtual spaces 205. Consider an example of a user 201, Jim, on a vacation who wants to share his experience with family members and friends. Jim may be on a vacation on a remote island where there is no internet connectivity. Jim uses his mobile phone to capture images and video during the vacation and stores it on his mobile device. He may also record a voice message describing his experience and the locations where the images were captured. The voice message and the images are stored on his mobile device. On reaching another place where internet connectivity is available, Jim may use the publishing service 204 to publish an audio accompanied slide show of the captured images. The slideshow may be published on Jim's personal blog site. Jim's family members and his friends may be able to view the slideshow on Jim's blog site and share his vacation experience, while Jim is continuing on with his vacation.

As another exemplary illustration, consider an investigative reporter, Samantha, working for a prominent newspaper in New York City. Each day, she moves around the city chasing leads, interviewing people, and tracking down her next big story. Her tools of choice are a notepad, a tape recorder, a camera, and a laptop. It is difficult for her to juggle the notepad and the tape recorder at the same time. It is also difficult for her to use the camera to capture pictures of an eminent personality amidst a huge crowd or who is boarding a vehicle. When she is working on a story with an associate writer, she needs to download the pictures and type her notes on the laptop and send it to the associate writer. Samantha learns about the publishing service 204 that allows her to publish pictures, videos, and audio from a mobile device to the internet with one click or touch of a button, and decides to give it a try. Soon, Samantha moves around the city with a smart phone that has replaced the notepad, the tape recorder and the camera. When she needs to take notes or remember important dates and facts about a story, she records her notes as an audio stream on her smart phone. The audio content is published and immediately available on her private blog that may be accessed by the newspaper editor and her associates in the news office. When she needs to review her notes, she logs into her blog site on her smart phone. She can see the video and the pictures that were captured and listen to the notes that she had recorded for herself. When she is collaborating with an associate on a story, they may see each other's progress in real time. Since sharing information with the associate over emails may be inconvenient, Samantha records her progress on the story in the voice format and publishes. The associate may access the information from Samantha's blog site, thereby saving considerable time.

Consider another example of a user 201 of the invention, Alex, who is an avid war game miniature collector and history buff. He is active in attending the numerous war gaming conventions and traveling to various historic locations to visualize the history he enjoys reading about. Alex has configured a couple of destination aliases for his account which allow him to send any media he generates to multiple blogs, or media repositories. His destination list includes the following aliases.
For war game miniatures: flickr (Miniature Album), blogger.com (WarGamer2000, a blog about development and maintenance of miniatures).
For history: picasa (History Album), blogger.com (HistoryNut, a blog about his thoughts and travels related to history).

Using this invention Alex is able to select a destination alias and transfer his photos or videos to multiple media sites with only a few selections from his mobile. In addition to the pre-defined list of destinations and aliases, Alex is able to include additional destinations such as email, and SMS to his post which are not added to his saved destination list. During one war gaming convention, Alex comes across a re-enactment of some historic civil war battle which he captures with his mobile handheld and posts via his miniatures alias. At the end of the day, he decides he would have really liked to send it to his history blog as well. Alex could have done this when initially creating the post, but did not think of it. So, he logs onto the web portion of the invention and logs into his account to find his most recent posts. From there he directs the application to also publish the post to his history blog and picasa History album.

Consider another example where the method and system of this invention is used in voice blogging. Radio and TV Talk Show programs commonly ask for voicemails and emails as a part of their material. With this invention, these viewers and listeners may now send messages to Radio or TV personality website directly. Users may send comments, pictures, even news coverage and send it directly to the programs or the host's website. Sometimes electronic mail may not be capable of communicating the full message. It may not convey the mood, the emotion, or the full personality of the sender.

Most people also usually listen to the radio in the car where the use of email is impractical. It is also very difficult to get through to a radio station by phone. A listener may now send their voice blog and thought to the website for everyone to see by just clicking on the voice capture media button on the graphical user interface 202a of the client application 202. With this invention, the radio staff may access these posts at any time and pick the ones they want to air and save it for later without ever needing to erase anything. They may also share more posts with their audience without the usual time constraints, and a larger audience may get their message across.

Television talk shows often employ the same tactics as radio shows, more often using email. Electronic mail may be very limiting for a television program especially when visual media may be used. This promotes more interaction between the show and the audience, and members may feel more certain their post will be noticed. Television programs such as talk shows, news programs, even reality television shows may use the invention to invite their audience to give feedback and comments. News programs may also use this invention in a number of ways. Firstly, similar to radio and talk show programs, news programs may take comments from the audience and add to the discussion or promote greater dialogue in a forum-style context on its website among audience members. They may also take polls more easily as well as receive coverage from people at ground zero for news worthy events that would otherwise be missed.

Exemplarily, the disclosed invention may be implemented in technologies that are pervasive, flexible, and capable enough of accomplishing the desired tasks of the disclosed invention. The electronic mobile device may be a ubiquitous mobile phone. The use of personal digital assistants (PDAs) without telephony support is also fairly widespread. The client application 202 may be deployed on such devices with limited or no telephony support. These mobile devices may support Java of Sun Microsystems Inc., more specifically Java 2 Micro Edition (J2ME™), Windows Mobile .Net Compact Framework of Microsoft, Inc., Symbian™, Linux framework. Exemplarily, the client application 202 may be implemented on the J2ME platform. These environments provide functionalities in the libraries to create the GUI 202a and perform all the required functions of the method and system disclosed herein. Other advantages of these frameworks are portability across mobile devices that run on different operating systems. The client application 202 may be rendered independent of the operating system of the mobile device. One of the transport mechanisms to achieve the connectivity between the publishing service 204 and the client application 202 is the wireless internet. While most PDAs have an inbuilt wireless network card for the internet connectivity, the mobile phones may transfer data to the publishing service 204 over the telephony network at near broadband speeds. Some of the mobile phones equipped with both wireless network and telephony data capabilities may use either of the two to communicate with the publishing service 204. The transport protocol that is used between the client application 202 and the publishing service 204 may be hypertext transfer protocol (HTTP) or extensible markup language-remote procedure calls (XML-RPC). The back end 204c service may be developed in Java.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described, such as the database 204a of the publishing service 204, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of publishing multimedia content created by a user of a mobile device on one or more publication virtual spaces simultaneously, comprising the steps of:
providing a client application on said mobile device of said user;
creating said multimedia content by the user using said client application;
providing a publishing service, wherein said publishing service comprises a front end service and a back end service;
synchronizing user publishing information between the client application and the publishing service using a protocol, wherein said user publishing information includes user preferences of said publication virtual spaces;
transferring said user created multimedia content from said mobile device to said back end service via said front end service, wherein said step of transferring the user created multimedia content is performed by the client application;
creating a multimedia object from said transferred multimedia content using the back end service;
transferring said multimedia object from the back end service to the front end service; and
publishing the multimedia object by the front end service on one or more of the publication virtual spaces simultaneously;
whereby the user created multimedia content is published on one or more of the publication virtual spaces by the publishing service.

2. The method of claim 1, wherein the multimedia object is spliced with targeted advertisements by the back end service based on profile of the user.

3. The method of claim 1, wherein the back end service sends targeted advertisements to the client application.

4. The method of claim 1, wherein the user created multimedia content is one of an audio file, a video file, an image file, a text file, and any combination thereof.

5. The method of claim 1, wherein the user created multimedia content is published using one of internet and intranet capabilities of the mobile device via a wireless network.

6. The method of claim 1, wherein the user created multimedia content is prerecorded multimedia content and published at a future point in time.

7. The method of claim 1, wherein the user created multimedia content is reviewed by the user prior to transferring the user created multimedia content to the back end service via the front end service.

8. The method of claim 1, wherein the user created multimedia content is transferred to the front end service as electronic mail attachments.

9. The method of claim 1, wherein the user created multimedia content is transferred to the front end service as data segments created by the client application.

10. The method of claim 9, wherein each of said data segments are tagged with segment identifiers.

11. The method of claim 10, wherein said tagged data segments are reassembled in a predetermined sequence using said segment identifiers by the back end service to create the multimedia object.

12. The method of claim 1, wherein said step of publishing the multimedia object is performed by a single input action of the user.

13. The method of claim 12, wherein said single input action of the user comprises one of a click and a touch of a button provided on a graphical user interface of the mobile device, one of a voice command, and a turn of a scroll wheel on the mobile device.

14. The method of claim 1, wherein said step of publishing the multimedia object includes one of pod casting, video casting, photo casting, text casting, voice blogging, photo blogging, text blogging, and a combination thereof.

15. The method of claim 1, wherein the publication virtual spaces are one or more of third party social networking websites, blog sites, video blog sites, social book marking websites, shopping websites, merchandising websites, and a plurality of websites that publish user created multimedia contents.

16. The method of claim 1, wherein the publication virtual spaces are configured by the user and said configuration is stored on the mobile device.

17. The method of claim 16, wherein the configuration of the publication virtual spaces are dynamically retrieved from the back end service by the client application.

18. The method of claim 1, wherein the user creates an account with the publishing service, wherein said publishing service account comprises login information of the user for the publication virtual spaces.

19. The method of claim 18, wherein said publishing service account comprises a user profile utilized for targeting advertisements.

20. The method of claim 1, wherein the publishing service generates advertising statistics based on viewing information of the multimedia object, wherein said viewing information is collected each time the multimedia object is viewed on the publication virtual spaces.

21. A system for publishing multimedia content created by a user of a mobile device on one or more publication virtual spaces simultaneously, comprising:
a client application on said mobile device for creating said multimedia content and selecting one or more of said publication virtual spaces by said user;
a publishing service for publishing a multimedia object on one or more of said selected publication virtual spaces, comprising:
a front end service for receiving said user created multimedia content and a list of the selected publication virtual spaces from said client application on the mobile device via a network, and publishing said multimedia object on the selected publication virtual spaces via said network; and
a back end service for creating the multimedia object from the user created multimedia content.

22. The system of claim 21, wherein the user created multimedia content is transferred from the client application to said back end service via said front end service as one of a single multimedia file, data segments, and one of a single and multiple multimedia files comprising electronic mail attachments.

23. The system of claim 21, wherein the client application comprises a graphical user interface for creating and transferring the user created multimedia content to said publishing service.

24. The system of claim 21, wherein the client application comprises a segmentation module, wherein said segmentation module partitions the user created multimedia content into data segments.

25. The system of claim 24, wherein said data segments are tagged with segment identifiers using the segmentation module.

26. The system of claim 25, wherein said tagged data segments are reassembled in a predetermined sequence by a data reassembler using said segment identifiers to create the multimedia object.

27. The system of claim 21, wherein the client application comprises an advertising module for displaying advertisements to the user on the mobile device.

28. The system of claim 21, wherein the client application comprises a publication virtual space list module for enlisting the publication virtual spaces for publishing of the user created multimedia content.

29. The system of claim 21, wherein the client application comprises a first user authentication module for authenticating the user to publish the user created multimedia content.

30. The system of claim 21, wherein the client application uses a media recorder for recording the multimedia content on the mobile device.

31. The system of claim 21, wherein said publishing service further comprises a database for storing user profiles, user preferences, advertisement profiles, advertisements, and user created multimedia content.

32. The system of claim 21, wherein said publishing service further comprises a second user authentication module for authenticating the user on the publishing service.

33. The system of claim 21, wherein said back end service comprises an advertisement selection tool for selecting targeted advertisements to be spliced with the multimedia object.

34. The system of claim 21, wherein said back end service comprises an advertisement splicer for splicing targeted advertisements with the multimedia object.

35. The system of claim 34, wherein said advertising splicer further sends targeted advertisements to the client application.

36. A computer program product comprising computer executable instructions embodied in a computer-readable medium, wherein said computer program product comprises:
a first computer parsable program code for creating multimedia content by a user;
a second computer parsable program code for synchronizing user publishing information between a client application on a mobile device and a publishing service using a protocol, wherein said user publishing information includes user preferences of publication virtual spaces;
a third computer parsable program code for transferring said user created multimedia content from said client application to a back end service via a front end service of said publishing service;
a fourth computer parsable program code for creating a multimedia object from said transferred multimedia content in said back end service;
a fifth computer parsable program code for transferring said multimedia object from the back end service to said front end service; and
a sixth computer parsable program code for publishing the multimedia object by the front end service on one or more of said publication virtual spaces simultaneously.
